(19) United States
(12) Patent Application Publication
(10) Pub. No.: US 2008/0010879 A1
(43) Pub. Date: Jan. 17, 2008

(54) Commercial sign

(76) Inventors: Andy Kaoh, Taipei Hsien (TW); Shieh-Hwei Lee Chen, Taipei Hsien (TW)

Correspondence Address: ANDY KAOH, 235 Chung-Ho Box 8-24, Taipei, omitted

(21) Appl. No.: 11/484,299

(22) Filed: Jul. 12, 2006

(51) Int. Cl. G09F 13/04

(52) U.S. Cl. 40/570

(57) ABSTRACT

A sign comprises a base cover, an LED circuit board, an upper cover and a matte-surface word board. The upper cover is provided with a decorative groove that will be changed when the word is changed. The word on the LED circuit board is composed of a multitude of LED light emitters, which can be switched one by one, thereby reducing the maintenance time and cost. The matte-surface word board can diffuse the light emitted therein and conceal the circuit board therein. The LED circuit board can change the flashing rate of the LED light emitters and simulate the effect of neon lights.

### FIELD OF THE INVENTION

The present invention relates to commercial signs, more particularly to a sign using an LED light circuit board for providing a set of words flashing at adjustable rate and capable of switching fonts. The light within the sign can be maintained or replaced quickly.

### BACKGROUND OF THE INVENTION

Each illuminating sign of the prior art has an upper of lower plate provided with a word, whereby the light emitter inside will underscore the word. A Conventional sign of another type has the word formed by a set of LED light emitters that cannot be changed separately s. Therefore, it is very costly and inconvenient to maintain the sign.

Accordingly, the present invention aims at removing the above-mentioned disadvantages.

### SUMMARY OF THE INVENTION

The primary objective of the present invention is to provide a sign comprising a base cover, an LED circuit board, an upper cover and a matte-surface word board. The upper cover is provided with a decorative groove that will be changed when the word is changed. Thereby, the decorative groove can be changed according to the word.

The secondary objective of the present invention is to provide a sign wherein the word on the LED circuit board is composed of a multitude of LED light emitters. The LED light emitters can be switched one by one, thereby reducing the maintenance time and cost.

It is a further objective of the present invention that the matte-surface word board can diffuse the light emitted therein and conceal the circuit board therein.

The LED circuit board can change the flashing rate of the LED light emitters and simulate the effect of neon lights.

Further, compared with conventional light bulbs, the LED light emitters embedded on the LED circuit board significantly save electric power.

The various objects and advantages of the present invention will be more readily understood from the following detailed description when read in conjunction with the appended drawings.

### BRIEF DESCRIPTION OF THE DRAWINGS

FIG. 1 is a front perspective view of a sign according to the present invention.

FIG. 2 is a rear perspective view of the sign in FIG. 1.

FIG. 3 illustrates the combined structure of the upper cover and the LED circuit board.

FIG. 4 is a perspective view of the sign in FIG. 1, indicating a word “OPEN”.

FIG. 5 is another perspective view of the sign in FIG. 1, showing the switch buttons on the rear side.

FIG. 6 is another perspective view of the sign in FIG. 1 illuminating the word “OPEN”.

FIG. 7 is another perspective view of the sign in FIG. 1 illuminating a parking indication.

### DETAILED DESCRIPTION OF THE PREFERRED EMBODIMENTS

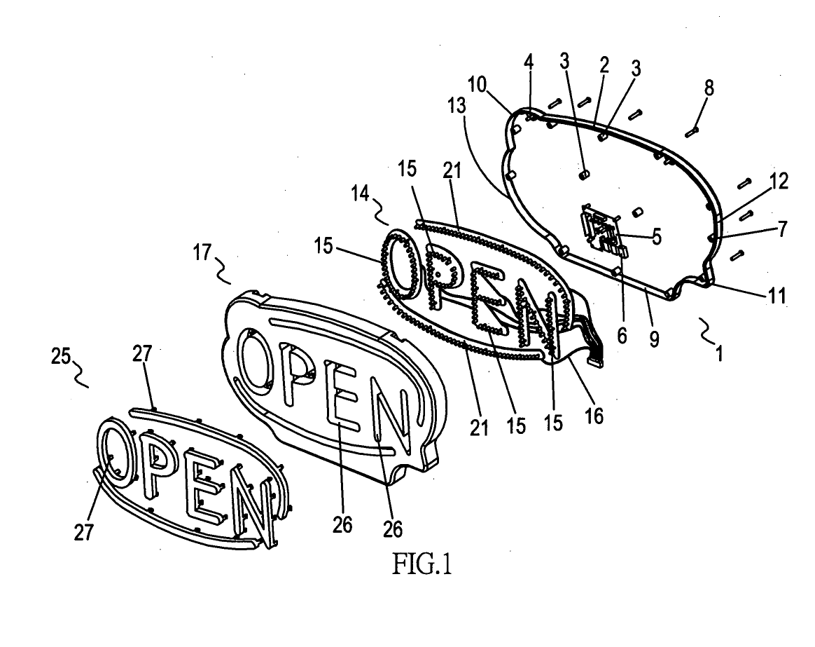

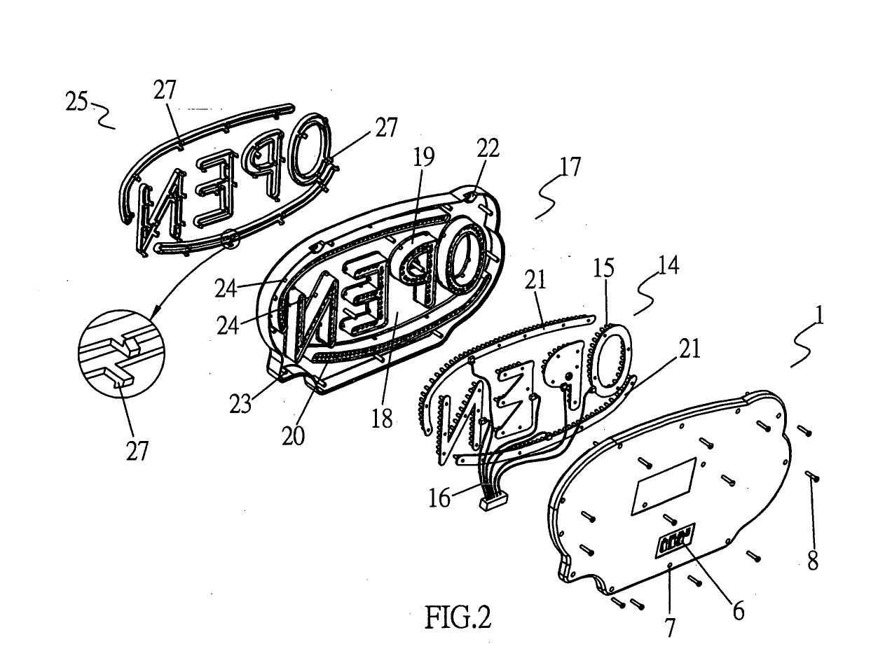

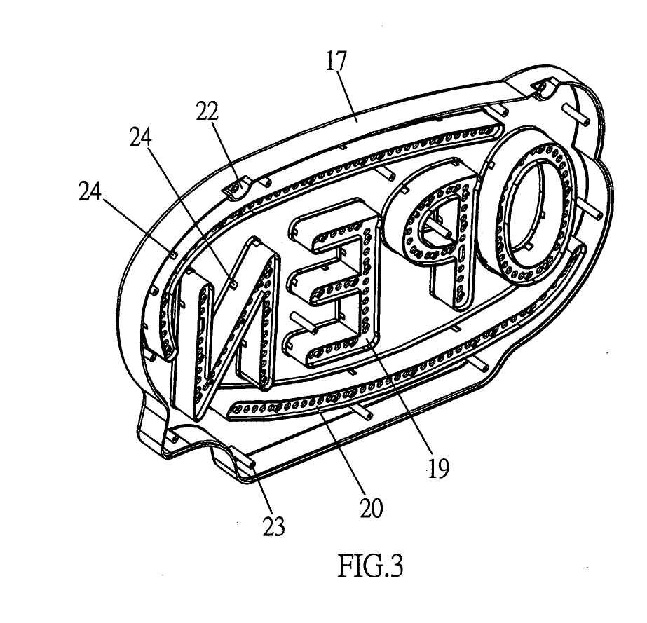

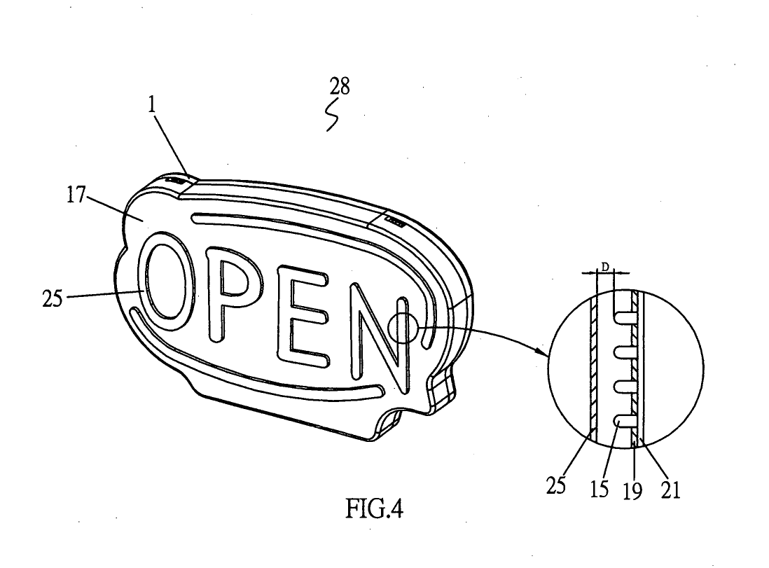

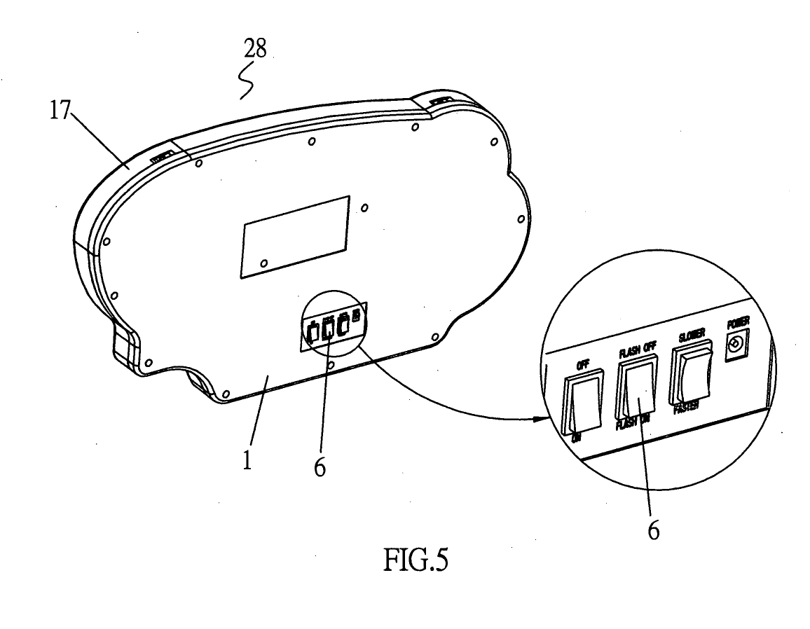

Referring to FIGS. 1, 2, 3 and 4, a sign accordingly to the present invention comprises a base cover 1 surrounded by a circumference wall 2. The inner space defined by the base cover 1 and the circumference wall 2 is further provided with a plurality of support posts 3 and a plurality of retaining posts 4. One lateral inner side of the inner space is provided with a circuit board 5 electrically connected to a button switch 6 embedded on the base cover, as shown in FIG. 5. Each of the retaining posts 4 is a hollow cylinder with an axial hole 7 for receiving a screw 8. Therefore, one side of the base cover 1 forms a flat surface 9, whose boundary has two outwardly bulged portions that form two ear parts 10, 11. By the ear parts 10, 11 there are respectively smoothly curved sections 12, 13.

The LED circuit board 14 is provided with a multitude of LED light emitters 15. The LED circuit board 14 is electrically connected to the circuit board 5 through a power cord 16, whereby the flashing rate of the LED light emitters 15 can be changed freely and an effect of neon lights will be simulated. Further, each character of the word is connected to the power independently, so that only part of the light emitters 15 will be replaced when the word display is malfunctioned. Further, the LED circuit board 14 may have different words thereon, such as OPEN, PARK . . .

The upper cover 17 capable of being engaged with the base cover 1 has a flat front surface and a rear surface forming a receptacle 18 with the base cover 1. The inner wall of the upper cover 17 is provided with embedment grooves 19 for engaging the LED circuit board 14. The embedment grooves 19 take the form of the word, which can be changed according to the word selected, such as OPEN, PARK . . . . The embedment grooves 19 are surrounded by a plurality of decorative grooves 20, each having a corresponding LED circuit board 21. Further, the embedment grooves 19 and the decorative grooves 20 are respectively provided with clipper grooves 24, whereby the embedment grooves 19 and the decorative grooves 20 will be protected by those inwardly erected walls. The upper cover 17 is further provided with insertion holes 22 and column-like holes 23. The insertion holes 22 are engaged with the retaining posts 4, and the column-like holes 23 are inserted through the axial holes 7 and fastened by screws 8. Thereby, the base cover 1, the LED circuit board 14 and the upper cover 17 are assembled. There are word slots 26 on the front surface of the upper cover 17 corresponding to the embedment grooves 19 and the decorative grooves 20, on which matte-surface word components 25 are engaged. The matte-surface word components 25 diffuse the LED light from the underneath the LED light emitters 15 and also conceal the light devices therein. Each of the matte-surface word components 25 is provided with a plurality of clip pieces 27, whereby they will be locked on the clipper grooves 24.

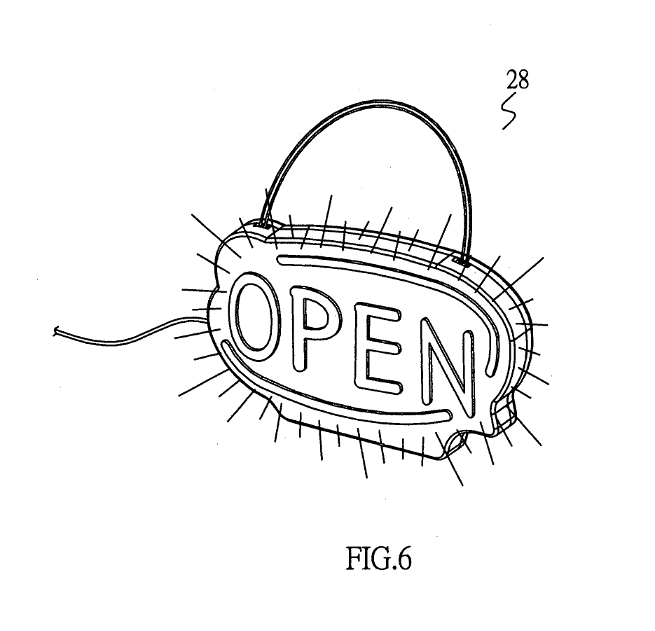

As shown in FIG. 6, the sign 28 can be used to indicate the direction of a place. The LED light emitters save electric power significantly.

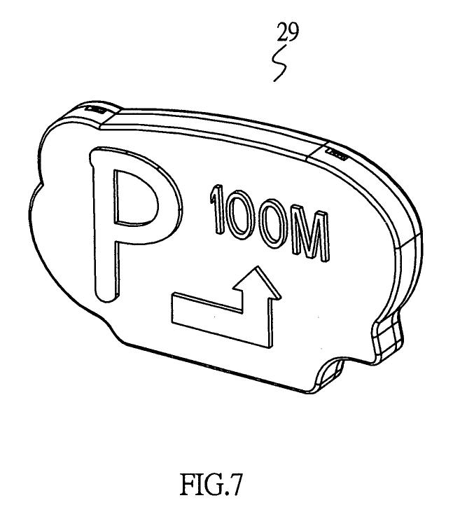

Further, the sign 28, together with the LED circuit board 14, the embedment grooves 19, the decorative grooves 20 and the matte-surface word components 25, can be modified to form a parking indicator 29, as shown in FIG. 7.

Further, the LED light emitters 15 on the LED circuit board 14 are kept at a distance from the matte-surface word components 25 to attain the best visual effect.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A sign, comprising:
a base cover surrounded by a circumference wall, said base cover further comprising a set of support posts and retaining posts, a lateral circuit board electrically connected to a switch;
an LED circuit board embedded with a multitude LED light emitters connected to said lateral circuit board of said base cover through a power cord, whereby the flashing rate of said LED light emitters will be changed freely and an effect of neon lights will be simulated, each character of a word formed by said LED light emitters being powered independently, whereby only a part of said LED light emitters 15 will be replaced when the display of said word is malfunctioned; and
an upper cover capable of being engaged with said base cover having a flat front surface and a rear surface that in turn forms a receptacle with said base cover, an inner wall of said upper cover being provided with a plurality of embedment grooves for housing said LED circuit board, said embedment grooves being surrounded by a plurality of decorative grooves, each of said decorative grooves having a corresponding LED circuit board, said embedment grooves and said decorative grooves are respectively provided with clipper grooves, whereby said embedment grooves and said decorative grooves will be protected by inwardly erected walls of said clipper grooves, said upper cover being further provided with insertion holes engaged with the retaining posts and column-like holes fastened by screws, word slots on said front surface of said upper cover being formed corresponding to said embedment grooves and said decorative grooves on which matte-surface word components are engaged for diffusing LED light from said LED light emitters and also conceal light devices therein, each of said matte-surface word components being provided with a plurality of clip pieces, whereby said matte-surface word components will be locked on said clipper grooves.

2. The sign of claim 1 wherein one side of said base cover forms a flat surface for mounting a word sign; two ear portions being formed along an outer rim of said base cover, by which smoothly curved contours are formed.

3. The sign of claim 1 wherein said retaining posts are formed within said receptacle above said base cover, each having a top through hole for holding a screw.

4. The sign of claim 1 wherein each character of said word displayed by said LED circuit board is powered independently, so that only a part of said light emitters will be replaced when said word display is malfunctioned; said LED circuit board being capable of being replaced for other word displays.

5. The sign of claim 1 wherein said embedment grooves are formed in said receptacle behind said upper cover for holding said LED circuit board; said embedment grooves being capable of being replaced for other word displays.

6. The sign of claim 1 wherein said decorative grooves are embedded with another LED circuit board similar to said LED circuit board for said embedment grooves; said decorative grooves and said embedment grooves being extended inwardly to form protective walls.

7. The sign of claim 1 wherein said LED circuit board, said embedment grooves and said matte-surface word components are capable of being replaced for other word displays.

8. The sign of claim 1 wherein said LED light emitters on said LED circuit board are kept at a distance 3-5 centimeters from said matte-surface word components for the best visual effect.
